(19) United States
(12) Patent Application Publication
(10) Pub. No.: US 2024/0429688 A1
(43) Pub. Date: Dec. 26, 2024

(54) HIGH-VOLTAGE DISTRIBUTION BOX HAVING OPEN CIRCUIT TRIGGER, COLLISION INITIATION SYSTEM, AND ELECTRIC VEHICLE

(71) Applicant: Changchun Jetty Automotive Technology Co., Ltd., Jilin (CN)

(72) Inventors: Chao WANG, Jilin (CN); Yong LIU, Jilin (CN)

(21) Appl. No.: 18/707,988

(22) PCT Filed: Nov. 8, 2022
(86) PCT No.: PCT/CN2022/130508

§ 371 Date: May 7, 2024

(30) Foreign Application Priority Data
Nov. 8, 2021 (CN) 202122718858.X

(51) Int. Cl. H02B 1/46; B60R 16/033; B60R 21/0136

(52) U.S. Cl. CPC H02B 1/46; B60R 16/033; B60R 21/0136

(57) ABSTRACT

A high-voltage distribution box having an open circuit trigger, a collision initiation system, and an electric vehicle include a distribution box housing, a first high-voltage connector, a second high-voltage connector, a low-voltage connector, and an open circuit trigger. The first high-voltage connector, the second high-voltage connector, and the low-voltage connector are provided on a surface of the distribution box housing, and the open circuit trigger is provided inside the distribution box housing. The first high-voltage connector and the second high-voltage connector are connected to a high-voltage loop of the electric automobile, and the first high-voltage connector and the second high-voltage connector are connected in series via the open circuit trigger. The low-voltage connector is connected to a control line of the electric automobile and configured to send an initiation control signal to the open circuit trigger at a moment of collision.

### RELATED APPLICATIONS

This application is a National Phase Entry of International Application No. PCT/CN2022/130508, filed Nov. 8, 2022, and claims priority to Chinese Patent Application No. 202122718858.X, filed on Nov. 8, 2021 and entitled “HIGH-VOLTAGE DISTRIBUTION BOX HAVING OPEN CIRCUIT TRIGGER, COLLISION INITIATION SYSTEM, AND ELECTRIC VEHICLE”, the disclosures of which are incorporated herein by reference in their entireties.

### TECHNICAL FIELD

The present disclosure relates to the field of electric vehicles, and in particular to a high-voltage distribution box having an open circuit trigger, a collision initiation system, and an electric vehicle.

### BACKGROUND

With the rapid development of the new energy industry, the number of electric vehicles is also increasing continuously. Massive electric vehicles meanwhile pose a huge safety hazard. The most critical is to timely disconnect the high-voltage loop of the electric vehicle when it experiences a collision, thus ensuring the safety both of the occupants and peripheral ambulance personnel.

The current measure being taken is that, upon collision, the airbag module sends out a power-off signal, which drives the relevant modules through a network or a hard wire to disconnect the main positive relay and main negative relay of the electric vehicle, so that the high-voltage system of the entire vehicle is powered down. If a relevant module, a circuit, or an actuator fails, the high-voltage loop of the electric vehicle cannot be disconnected in time, leading to injury or fatality caused by electric shock.

How to promptly disconnect the high-voltage loop of the entire vehicle after a collision of the electric vehicle is a problem to be resolved urgently in the prior art.

### SUMMARY

An objective of the present disclosure is to provide a high-voltage distribution box having an open circuit trigger, a collision initiation system, and an electric vehicle, such that when the electric vehicle experiences a collision, the high-voltage loop of the entire vehicle is disconnected immediately to reduce human casualties.

The foregoing objective of the present disclosure can be achieved using the following technical solution:

An embodiment of the present disclosure provides a high-voltage distribution box having an open circuit trigger, including:

a distribution box housing, a first high-voltage connector, a second high-voltage connector, a low-voltage connector, and an open circuit trigger.

The first high-voltage connector, the second high-voltage connector, and the low-voltage connector are provided on a surface of the distribution box housing, and the open circuit trigger is provided inside the distribution box housing.

The first high-voltage connector and the second high-voltage connector are connected to a high-voltage loop of an electric automobile, and the first high-voltage connector and the second high-voltage connector are connected in series via the open circuit trigger.

The low-voltage connector is connected to a control line of the electric automobile and configured to send an initiation control signal to the open circuit trigger at a moment of collision.

According to another aspect of the embodiments of the present disclosure, the first high-voltage connector includes a first positive electricity connection terminal and a first negative electricity connection terminal, the second high-voltage connector includes a second positive electricity connection terminal and a second negative electricity connection terminal, and the open circuit trigger further includes a main positive open circuit trigger and a main negative open circuit trigger.

The main positive open circuit trigger is connected in series between the first positive electricity connection terminal and the second positive electricity connection terminal, and the main negative open circuit trigger is connected in series between the first negative electricity connection terminal and the second negative electricity connection terminal.

According to another aspect of the embodiments of the present disclosure, the open circuit trigger further includes a connecting pin and a trigger, and the connecting pin is movably connected between a first end of the open circuit trigger and a second end thereof.

The trigger is provided at an end of the connecting pin and connected to the low-voltage connector and receives the initiation control signal.

According to another aspect of the embodiments of the present disclosure, the trigger further includes a trigger resistor and an expansion component, the trigger resistor is connected to the low-voltage connector, and the expansion component is provided at an end of the connecting pin.

The trigger resistor is configured to, upon receipt of the initiation control signal, control the expansion component to swell and deform to enable the connecting pin to disconnect the connection between the first end of the open circuit trigger and the second end of the open circuit trigger.

According to another aspect of the embodiments of the present disclosure, the expansion component is an explosive.

According to another aspect of the embodiments of the present disclosure, the high-voltage distribution box further includes a high-voltage repeater, and the high-voltage repeater is provided inside the distribution box housing.

The high-voltage repeater and the open circuit trigger are connected in series between the first high-voltage connector and the second high-voltage connector.

The low-voltage connector is further configured to, in a normal operation state, receive a control signal sent to the high-voltage repeater.

According to another aspect of the embodiments of the present disclosure, the high-voltage distribution box of the electric automobile further includes a high-voltage circuit breaker and the high-voltage circuit breaker is provided inside the distribution box housing.

The high-voltage open circuit trigger and the open circuit trigger are connected in series between the first high-voltage connector and the second high-voltage connector.

The high-voltage open circuit trigger is configured to disconnect the series connection of the first high-voltage connector and the second high-voltage connector in a case of a short circuit in the high-voltage loop of the electric automobile or an excess load of the electric automobile.

According to another aspect of the embodiments of the present disclosure, the high-voltage distribution box of the electric automobile further includes a copper busbar and an insulation fixing block, and the copper busbar and the insulation fixing block are provided inside the distribution box housing.

The copper busbar and the open circuit trigger are connected in series between the first high-voltage connector and the second high-voltage connector, to conduct a high-voltage current between the first high-voltage connector and the second high-voltage connector inside the distribution box housing.

The insulation fixing block wraps the copper busbar and is configured to fix the copper busbar inside the distribution box housing.

The embodiments of the present disclosure further include a collision initiation system, including the high-voltage distribution box having an open circuit trigger provided by the embodiments of the present disclosure, an airbag ECU (Electronic Control Unit), a collision sensor, and an airbag initiator.

The airbag ECU is connected to the low-voltage connector of the high-voltage distribution box having the open circuit trigger, and the collision sensor and the airbag initiator are respectively connected to the airbag ECU.

The airbag ECU is configured to, after determining a collision status of the electric automobile based on a signal of the collision sensor and a signal of the airbag initiator, send the initiation control signal to the low-voltage connector of the high-voltage distribution box having the open circuit trigger.

The embodiments of the present disclosure further provide the collision initiation system provided by the embodiments of the present disclosure, an electric automobile, including an automobile body, and a high-voltage battery.

The high-voltage battery and the collision initiation system are provided in the automobile body.

The high-voltage distribution box having the open circuit trigger is connected to the high-voltage battery and configured to control the high-voltage battery to supply power to a high-voltage appliance of the automobile body.

According to the embodiments of the present disclosure, when the electric vehicle experiences a collision, the control line of the electric vehicle sends an initiation control signal for initiating the open circuit trigger to the low-voltage connector. Upon receipt of the initiation control signal, the open circuit trigger immediately disconnects the series connection of the first high-voltage connector and the second high-voltage connector in the high-voltage distribution box, so as to disconnect the high-voltage loop of the electric vehicle which is connected to both of the first high-voltage connector and the second high-voltage connector, so that the high-voltage system of the entire vehicle is powered down, thereby reducing economic loss due to the collision of the electric vehicle and human casualties.

### BRIEF DESCRIPTION OF THE DRAWINGS

To describe the technical solutions in the embodiments of the present disclosure and the prior art more clearly, the drawings to be used in the description of the embodiments or the prior art will be briefly described below. Obviously, the drawings in the following description show only some embodiments of the present disclosure, and persons of ordinary skill in the art may still obtain other drawings from these drawings without inventive efforts.

FIG. 1a is a schematic structural diagram of a high-voltage distribution box having an open circuit trigger according to an embodiment of the present disclosure.

FIG. 1b is a schematic structural diagram of a high-voltage distribution box having an open circuit trigger according to an embodiment of the present the present disclosure.

FIG. 2 is a specific structural diagram of a high-voltage distribution box having an open circuit trigger according to an embodiment of the present the present disclosure.

FIG. 3 is a schematic structural diagram of an open circuit trigger according to an embodiment of the present the present disclosure.

FIG. 4 is a schematic structural diagram of a collision initiation system according to an embodiment of the present the present disclosure.

FIG. 5 is a schematic structural diagram of an electric automobile according to an embodiment of the present the present disclosure.

### REFERENCE NUMERALS

101. distribution box housing

102. first high-voltage connector

103. second high-voltage connector

104. low-voltage connector
105. main positive open circuit trigger
106. main negative open circuit trigger
107. first positive electricity connection terminal
108. first negative electricity connection terminal
109. second positive electricity connection terminal
110. second negative electricity connection terminal
111. open circuit trigger
201. distribution-box lower housing
202. distribution-box upper cover
203. first high-voltage connector
204. second high-voltage connector
205. low-voltage connector
206. main positive open circuit trigger
207. main negative open circuit trigger
208. open circuit trigger control wire
209. main positive copper busbar
210. main negative copper busbar
211. first positive electricity connection terminal
212. first negative electricity connection terminal
213. second positive electricity connection terminal
214. second negative electricity connection terminal
215. high-voltage repeater
216. high-voltage repeater control wire
217. high-voltage circuit breaker
218. fixing bolt
219. insulation fixing block
301. connecting pin
302. trigger
303. trigger resistor
304. expansion component
305. open circuit trigger control wire
306. first end of the open circuit trigger
307. second end of the open circuit trigger
401. high-voltage battery
402. airbag ECU
403. collision sensor
404. airbag initiator
405. high-voltage distribution box
406. high-voltage appliance
407. open circuit trigger
408. left front collision sensor
409. right front collision sensor
410. left side collision sensor
411. right side collision sensor
412. forward collision sensor
413. driver airbag initiator
414. driver side airbag initiator
415. passenger airbag initiator
416. passenger side airbag initiator
501. right front collision sensor
502. left front collision sensor
503. right side collision sensor
504. left side collision sensor
505. passenger airbag initiator
506. driver airbag initiator
507. passenger side airbag initiator
508. driver side airbag initiator
509. high-voltage battery
510. airbag ECU
511. high-voltage distribution box
512. automobile body

### DESCRIPTION OF THE EMBODIMENTS

The following clearly and completely describes the technical solutions in the embodiments of the present disclosure with reference to the drawings in the embodiments of the present disclosure. Obviously, the described embodiments are only some rather than all of the embodiments of the present disclosure. All other embodiments obtained by persons of ordinary skill in the art based on the embodiments of the present disclosure without inventive efforts shall fall within the protection scope of the present disclosure.

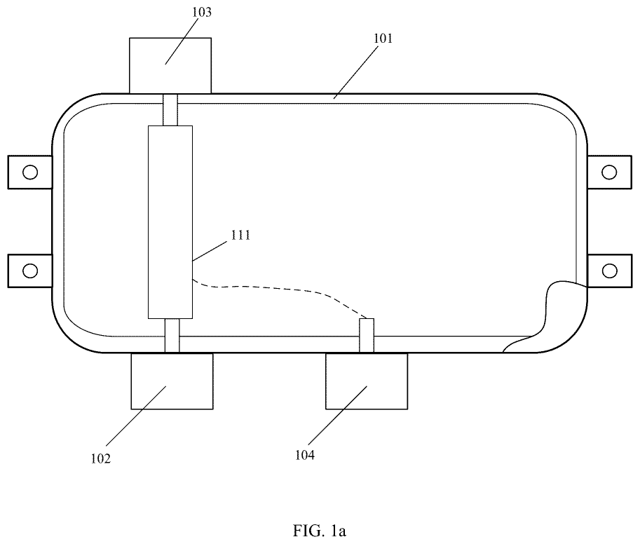

FIG. 1a is a schematic structural diagram of a high-voltage distribution box having an open circuit trigger according to an embodiment of the present disclosure. The high-voltage distribution box having an open circuit trigger shown therein includes a distribution box housing 101, a first high-voltage connector 102, a second high-voltage connector 103, a low-voltage connector 104, and an open circuit trigger 111.

The first high-voltage connector 102, the second high-voltage connector 103, and the low-voltage connector 104 are provided on a surface of the distribution box housing 101, and the open circuit trigger 111 is provided inside the distribution box housing 101.

The first high-voltage connector 102 and the second high-voltage connector 103 are connected to a high-voltage loop of an electric vehicle (for example, an electric automobile, where electric vehicles in the embodiments described below are all referred to as electric automobiles, but it does not exclude that other electric vehicles also use the structure of the present disclosure as a high-voltage distribution box), and the first high-voltage connector 102 and the second high-voltage connector 103 are connected in series via the open circuit trigger 111.

The low-voltage connector 104 is connected to a control line of the electric automobile and configured to send an initiation control signal to the open circuit trigger 111 at a moment of collision.

In the embodiments of the present disclosure, a high-voltage battery of the electric automobile is connected to a high-voltage appliance (for example, a motor) of an electric automobile via the high-voltage distribution box as shown in FIG. 1a, where a current output terminal of the high-voltage battery is connected to the first high-voltage connector 102, and a power supply wire of the high-voltage appliance is connected to the second high-voltage connector

During normal operation of the electric automobile, current of the high-voltage battery sequentially passes through the first high-voltage connector 102, the open circuit trigger 111, and the second high-voltage connector 103 to the high-voltage appliance.

When the electric automobile experiences a collision, a control system of the electric automobile sends an initiation control signal to the open circuit trigger 111 via a control line of the electric automobile. The low-voltage connector 104 is connected to the control line of the electric automobile and sends the initiation control signal to the open circuit trigger 111. After receiving the initiation control signal, the open circuit trigger 111 immediately disconnects the series connection of the first high-voltage connector 102 and the second high-voltage connector 103, thus disconnecting the high-voltage battery of the electric automobile from the high-voltage appliance, so that the high-voltage loop of the electric automobile is powered down.

With the use of the high-voltage distribution box having the open circuit trigger of the embodiments of the present disclosure, when the electric automobile experiences a collision, the high-voltage loop of the electric automobile is disconnected immediately to power down the high-voltage system of the entire vehicle, reducing economic loss due to the collision of the electric automobile and human casualties.

In addition, the current output terminal of the high-voltage battery may be also connected to the second high-voltage connector 103, and the power supply wire of the high-voltage appliance is connected to the first high-voltage connector 102. It is easy for those of ordinary skills to think of the operation process of the high-voltage distribution box with such connection method based on content of the foregoing embodiments, and details are not repeated in the embodiments of this specification.

In an embodiment of the present disclosure, to further ensure the safety of the positive and negative high-voltage loops when the electric automobile experiences a collision, as shown in FIG. 1b, the first high-voltage connector 102 includes a first positive electricity connection terminal 107 and a first negative electricity connection terminal 108, the second high-voltage connector 103 includes a second positive electricity connection terminal 109 and a second negative electricity connection terminal 110, and the open circuit trigger 111 further includes a main positive open circuit trigger 105 and a main negative open circuit trigger 106.

The main positive open circuit trigger 105 is connected in series between the first positive electricity connection terminal 107 and the second positive electricity connection terminal 109, and the main negative open circuit trigger 106 is connected in series between the first negative electricity connection terminal 108 and the second negative electricity connection terminal 110.

In the embodiments of the present disclosure, a positive electrode of the high-voltage battery is connected to the first positive electricity connection terminal 107, a negative electrode of the high-voltage battery is connected to the first negative electricity connection terminal 108, the second positive electricity connection terminal 109 is connected to a positive electrode of the high-voltage appliance, and the second negative electricity connection terminal 110 is connected to a negative electrode of the high-voltage appliance.

During normal operation of the electric automobile, the positive electrode of the high-voltage battery outputs a current of a positive loop to the first positive electricity connection terminal 107, the current sequentially passing through the open circuit trigger 111 and the second positive electricity connection terminal 109 to arrive at the positive electrode of the high-voltage appliance, and then the high-voltage appliance outputs a current of a negative loop to the second negative electricity connection terminal 110, the current sequentially passing through the open circuit trigger 111 and the first negative electricity connection terminal 108 to arrive at the negative electrode of the high-voltage battery.

In the embodiments of the present disclosure, during normal operation of the electric automobile, the positive electrode of the high-voltage battery outputs a current of a positive loop to the first positive electricity connection terminal 107, the current sequentially passing through the main positive open circuit trigger 105 and the second positive electricity connection terminal 109 to arrive at the positive electrode of the high-voltage appliance, and then the high-voltage appliance outputs a current of a negative loop to the second negative electricity connection terminal 110, the current passing through the main negative open circuit trigger 106 and the first negative electricity connection terminal 108 to arrive at the negative electrode of the high-voltage battery.

When the electric automobile experiences a collision, the control system of the electric automobile sends an initiation control signal to both of the main positive open circuit trigger 105 and the main negative open circuit trigger 106 via the control line of the electric automobile. The low-voltage connector 104 is connected to the control line of the electric automobile and sends the initiation control signal to both of the main positive open circuit trigger 105 and the main negative open circuit trigger 106. Upon receipt of the initiation control signal, the main positive open circuit trigger 105 immediately disconnects the series connection of the first positive electricity connection terminal 107 and the second positive electricity connection terminal 109. Upon receipt of the initiation control signal, the main negative open circuit trigger 106 immediately disconnects the series connection of the first negative electricity connection terminal 108 and the second negative electricity connection terminal 110, thus disconnecting the positive electrode of the high-voltage battery from the positive electrode of the high-voltage appliance and disconnecting the negative electrode of the high-voltage battery from the negative electrode of the high-voltage appliance, so that the positive and negative high-voltage loops of the electric automobile are powered down.

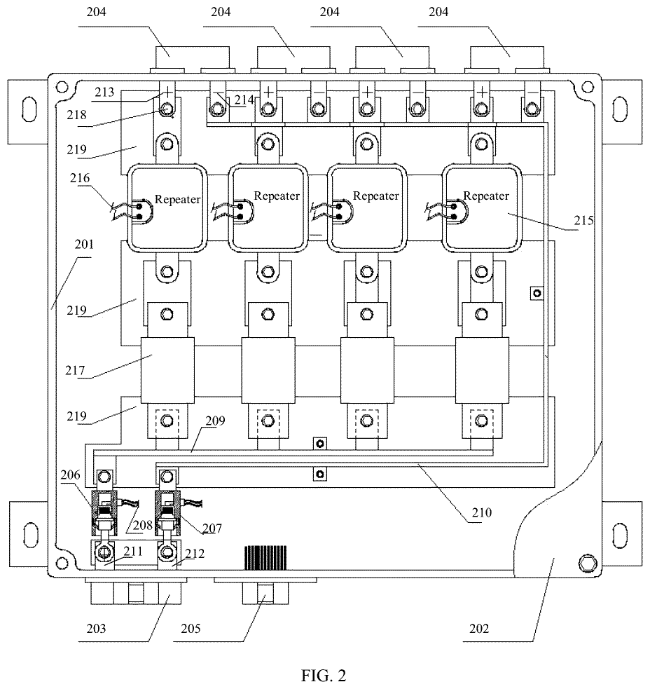

In an embodiment of the present disclosure, as shown in FIG. 3, the open circuit trigger 111 further includes a connecting pin 301 and a trigger 302, and the connecting pin 301 is movably connected between a first end 306 of the open circuit trigger and a second end 307 thereof.

The trigger 302 is provided at an end of the connecting pin 301 and connected to the low-voltage connector 104 and receives the initiation control signal.

In the embodiments of the present disclosure, the first end 306 of the open circuit trigger is connected to the first high-voltage connector 102, and the second end 307 of the open circuit trigger is connected to the second high-voltage connector 103. When the electric automobile malfunctions, the trigger 302 receives the initiation control signal, enabling the connecting pin 301 to disconnect the connection between the first end 306 of the open circuit trigger and the second end 307 of the open circuit trigger, thus disconnecting the series connection of the first high-voltage connector 102 and the second high-voltage connector 103, so that the high-voltage of the entire vehicle is powered down.

In an embodiment of the present disclosure, as shown in FIG. 3, the trigger 302 further includes a trigger resistor 303 and an expansion component 304, the trigger resistor 303 is connected to the low-voltage connector 104, and the expansion component 304 is provided at an end of the connecting pin 301.

The trigger resistor 303 is configured to, upon receipt of the initiation control signal, control the expansion component 304 to swell and deform to enable the connecting pin 301 to disconnect the connection between the first end 306 of the open circuit trigger and the second end 307 of the open circuit trigger.

In the embodiments of the present disclosure, the expansion component 304 may be an explosive or a gas generator. Exemplarily, the expansion component 304 described in the embodiments of the present disclosure is an explosive. When the expansion component 304 is an explosive, after receiving the initiation control signal, the trigger resistor 303 rapidly heats up and ignites the explosive to enable the explosive to blast the connecting pin 301, so as to disconnect the connection between the first end 306 of the open circuit trigger and the second end 307 of the open circuit trigger. When the expansion component 304 is a gas generator, upon receipt of the initiation control signal, the trigger resistor 303 rapidly heats up and causes the gas generator to swell and deform to enable the connecting pin 301 to disconnect the connection between the first end 306 of the open circuit trigger and the second end 307 of the open circuit trigger. In addition, the expansion component may be another structure, which is not limited in the embodiments of this specification.

In the embodiments of the present disclosure, as shown in FIG. 3, the open circuit trigger 111 may further include an open circuit trigger control wire 305 connected in series between the trigger resistor 303 and the first low-voltage connector 104 and configured to transmit the initiation control signal to the trigger resistor 303.

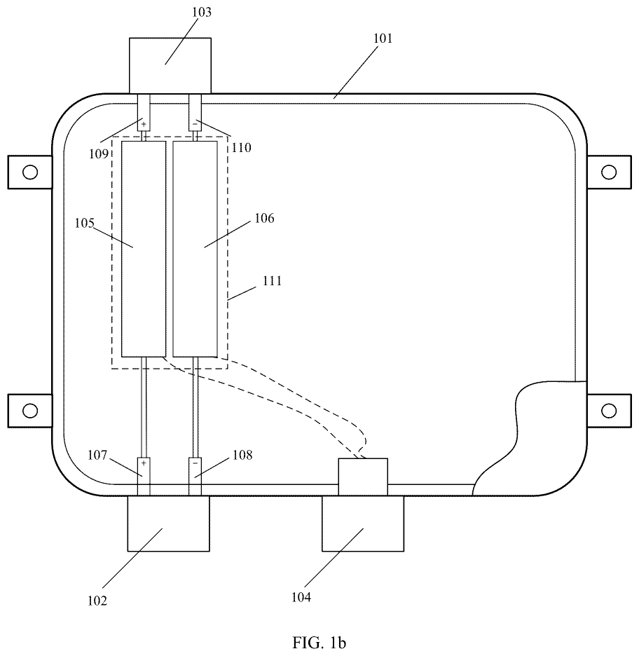

In an embodiment of the present disclosure, as shown in FIG. 2, the distribution box housing 101 further includes a distribution-box lower housing 201 and a distribution-box upper cover 202. The distribution-box lower housing 201 may be connected to the distribution-box upper cover 202 through a bolt. The open circuit trigger 111 shown in FIG. 1a or FIG. 1b is provided inside an enclosed space formed by the distribution-box lower housing 201 and the distribution-box upper cover 202. The distribution-box lower housing 201 may be further connected to the distribution-box upper cover 202 in another connection manner, which is not limited in the embodiments of this specification.

In an embodiment of the present disclosure, to control power supply or power cut-off of the high-voltage appliance using the high-voltage distribution box in the embodiments of the present disclosure when the electric automobile is in a normal operation state, as shown in FIG. 2, the high-voltage distribution box further includes a high-voltage repeater 215 provided inside an enclosed space formed by the distribution-box lower housing 201 and the distribution-box upper cover 202.

The high-voltage repeater 215 and the main positive open circuit trigger 206 are connected in series between the first high-voltage connector 203 and the second high-voltage connector 204.

The low-voltage connector 205 is further configured to, in a normal operation state, receive a control signal sent to the high-voltage repeater 215.

In the embodiments of the present disclosure, the connection order of the first high-voltage connector 203, the second high-voltage connector 204, the high-voltage repeater 215, and the open circuit trigger may be from the first high-voltage connector 203 to the main positive open circuit trigger 206, the high-voltage repeater 215, and then to the second high-voltage connector 204. The order of the high-voltage repeater 215 and the open circuit trigger may be exchanged.

In a normal operation state, a high-voltage battery electronic control unit (ECU) of the electric automobile sends, based on an operation situation of the electric automobile, a control signal to the high-voltage repeater 215 via the control line of the electric automobile. The low-voltage connector 205 is connected to the control line of the electric automobile and sends the control signal of the high-voltage repeater 215 to the high-voltage repeater 215. After receiving the control signal, the high-voltage repeater 215 disconnects the series connection of the first high-voltage connector 203 and the second high-voltage connector 204, thus disconnecting the high-voltage battery of the electric automobile from the high-voltage appliance.

As shown in FIG. 2, the open circuit trigger 111 further includes a main positive open circuit trigger 206 and a main negative open circuit trigger 207. Exemplarily, the high-voltage repeater 215 and the main positive open circuit trigger 206 are connected in series between the first positive electricity connection terminal 211 of the first high-voltage connector 203 and the second positive electricity connection terminal 213 of the second high-voltage connector 204. After receiving the control signal, the high-voltage repeater 215 disconnects the series connection of the first positive electricity connection terminal 211 and the second positive electricity connection terminal 213, thus disconnecting the positive high-voltage loop of the electric automobile.

As shown in FIG. 2, the high-voltage distribution box may include a plurality of second high-voltage connectors 204, each second high-voltage connector 204 being connected to a different high-voltage appliance. In addition, based on the quantity of the second high-voltage connectors 204, the high-voltage distribution box may include a plurality of high-voltage repeaters 215, and the high-voltage repeaters 215 are in one-to-one correspondence to the second high-voltage connectors 204. The high-voltage battery ECU of the electric automobile can control each high-voltage repeater 215, so as to control power supply or power cut-off of different high-voltage appliances.

In an embodiment of the present disclosure, as shown in FIG. 2, the high-voltage distribution box may further include a high-voltage repeater control wire 216, and the high-voltage repeater control wire 216 has one end connected to the high-voltage repeater 215 and the other end connected to the low-voltage connector 205, for transmitting the control signal of the high-voltage repeater 215 from the low-voltage connector 205 to the high-voltage repeater 215.

In an embodiment of the present disclosure, when the high-voltage loop of the electric automobile experiences a short circuit or the high-voltage appliance has an excess load, to protect the high-voltage loop of the electric automobile using the high-voltage distribution box, as shown in FIG. 2, the high-voltage distribution box may further include a high-voltage circuit breaker 217 provided inside an enclosed space formed by the distribution-box lower housing 201 and the distribution-box upper cover 202.

The high-voltage circuit breaker 217 and the main positive open circuit trigger 206 are connected in series between the first high-voltage connector 203 and the second high-voltage connector 204.

The high-voltage circuit breaker 217 is configured to disconnect the series connection of the first high-voltage connector 203 and the second high-voltage connector 204 in a case of a short circuit in the high-voltage loop of the electric automobile or an excess load of the electric automobile.

In the embodiments of the present disclosure, the first high-voltage connector 203, the second high-voltage connector 204, the high-voltage circuit breaker 217, and the main positive open circuit trigger 206 are connected in the same order of the high-voltage repeater 215 of the embodiments of the present disclosure, and thus details are not described in the embodiments of the present disclosure.

When the high-voltage loop of the electric automobile is prone to a short circuit or the high-voltage appliance has an excess load, the high-voltage circuit breaker 217 disconnects the series connection of the first high-voltage connector 203 and the second high-voltage connector 204, thus disconnecting the high-voltage loop and protecting the high-voltage loop of the electric automobile.

As shown in FIG. 2, the open circuit trigger 111 includes a main positive open circuit trigger 206 and a main negative open circuit trigger 207. Exemplarily, the high-voltage circuit breaker 217 and the main positive open circuit trigger 206 are connected in series between the first positive electricity connection terminal 211 of the first high-voltage connector 203 and the second positive electricity connection terminal 213 of the second high-voltage connector 204. When the high-voltage loop of the electric automobile is prone to a short circuit or the high-voltage appliance has an excess load, the high-voltage circuit breaker 217 disconnects the series connection of the first positive electricity connection terminal 211 and the second positive electricity connection terminal 213, thus disconnecting the positive high-voltage loop of the electric automobile.

As shown in FIG. 2, the high-voltage distribution box may include a plurality of high-voltage circuit breakers 217, and the high-voltage circuit breakers 217 are in one-to-one correspondence to the second high-voltage connectors 204, such that when one high-voltage appliance is prone to a short circuit or has an excess load, the series connection of the second high-voltage connector 204 connected to the high-voltage appliance and the first high-voltage connector 203 is disconnected separately, thus ensuring the normal operation of the other high-voltage appliances that have not been prone to a short circuit or an excess load.

In an embodiment of the present disclosure, to increase the maximum current conducted by the high-voltage distribution box, as shown in FIG. 2, the high-voltage distribution box may further include a copper busbar (a main positive copper busbar 209 and a main negative copper busbar 210) and an insulation fixing block 219. The main positive copper busbar 209, the main negative copper busbar 210, and the insulation fixing block 219 are provided in an enclosed space formed by the distribution-box lower housing 201 and the distribution-box upper cover 202.

The main positive copper busbar 209 and the main positive open circuit trigger 206 are connected in series between the first high-voltage connector 203 and the second high-voltage connector 204 (the main negative copper busbar 210 and the main negative open circuit trigger 207 are connected in series between the first high-voltage connector 203 and the second high-voltage connector 204), to conduct a high-voltage current between the first high-voltage connector 203 and the second high-voltage connector 204 inside the distribution box housing.

The insulation fixing block 219 wraps the main positive copper busbar 209 or the main negative copper busbar 210, to fix the copper busbar inside the distribution box housing.

In the embodiments of the present disclosure, due to a large cross-sectional area of the main positive copper busbar 209 or the main negative copper busbar 210, a larger current can be conducted. In addition, the main positive copper busbar 209 or the main negative copper busbar 210 is exposed in the high-voltage distribution box, to prevent a plurality of main positive copper busbars 209 and/or main negative copper busbars 210 from causing a short circuit, the insulation fixing block 219 wraps the main positive copper busbar 209 or the main negative copper busbar 210 and fixes the main positive copper busbar 209 and the main negative copper busbar 210 inside the distribution box housing.

As shown in FIG. 2, the high-voltage distribution box may include a plurality of main positive copper busbars 209, main negative copper busbars 210, and insulation fixing blocks 219. Each copper busbar is connected to the open circuit trigger, the first high-voltage connector 203, and the second high-voltage connector 204 in series. Fixing bolts 218 may be used to connect the main positive copper busbar 209 to the main positive open circuit trigger, and may be used to connect the main negative copper busbar 210 to the second high-voltage connector 204 or both of the main negative open circuit trigger 207 and the first high-voltage connector 203.

As shown in FIG. 2, the open circuit trigger 111 further includes the main positive open circuit trigger 206 and the main negative open circuit trigger 207. Exemplarily, the copper busbar further includes a main positive copper busbar 209 and a main negative copper busbar 210. The main positive copper busbar 209 and the main positive open circuit trigger 206 are connected in series between the first positive electricity connection terminal 211 of the first high-voltage connector 203 and the second positive electricity connection terminal 213 of the second high-voltage connector 204, and the main negative copper busbar 210 and the main negative open circuit trigger 207 are connected in series between the first negative electricity connection terminal 212 of the first high-voltage connector 203 and the second negative electricity connection terminal 214 of the second high-voltage connector 204. The main positive copper busbar 209 conducts a positive high-voltage current between the first positive electricity connection terminal 211 and the second positive electricity connection terminal 213 inside the distribution box housing, and the main negative copper busbar 210 conducts a negative high-voltage current between the first negative electricity connection terminal 212 and the second negative electricity connection terminal 214 inside the distribution box housing.

In an embodiment of the present disclosure, as shown in FIG. 2, the high-voltage distribution box may further include a high-voltage repeater 215, a high-voltage circuit breaker 217, a copper busbar, and an insulation fixing block 219. The high-voltage repeater 215, the high-voltage circuit breaker 217, the copper busbar, and the insulation fixing block 219 are provided in the enclosed space formed by the distribution-box lower housing 201 and the distribution-box upper cover 202.

The high-voltage repeater 215, the high-voltage circuit breaker 217, the copper busbar, and the open circuit trigger 111 are connected in series between the first high-voltage connector 203 and the second high-voltage connector 204.

In the embodiments of the present disclosure, the series connection order of the high-voltage repeater 215, the high-voltage circuit breaker 217, and the open circuit trigger 111 is not limited in the present disclosure.

As shown in FIG. 2, the open circuit trigger 111 further includes a main positive open circuit trigger 206 and a main negative open circuit trigger 207. Exemplarily, the high-voltage repeater 215, the high-voltage circuit breaker 217, the main positive copper busbar 209, and the main positive open circuit trigger 206 are connected in series between the first positive electricity connection terminal 211 of the first high-voltage connector 203 and the second positive electricity connection terminal 213 of the second high-voltage connector 204, and the main negative copper busbar 210 and the main negative open circuit trigger 207 are connected between the first negative electricity connection terminal 212 of the first high-voltage connector 203 and the second negative electricity connection terminal 214 of the second high-voltage connector 204.

In a normal operation state, the high-voltage battery ECU of the electric automobile sends, based on the operation situation of the electric automobile, a control signal to the high-voltage repeater 215 via the control line of the electric automobile. The low-voltage connector 205 is connected to the control line of the electric automobile and sends the control signal of the high-voltage repeater 215 to the high-voltage repeater 215. After receiving the control signal, the high-voltage repeater 215 disconnects the series connection of the first positive electricity connection terminal 211 and the second positive electricity connection terminal 213, thus disconnecting the connection between the positive electrode of the high-voltage battery of the electric automobile and the positive electrode of the high-voltage appliance.

When the high-voltage loop of the electric automobile is prone to a short circuit or the high-voltage appliance has an excess load, the high-voltage circuit breaker 217 disconnects the series connection of the first positive electricity connection terminal 211 and the second positive electricity connection terminal 213, thus disconnecting the positive high-voltage loop.

With the use of the high-voltage distribution box having an open circuit trigger of the embodiments of the present disclosure, when the electric automobile experiences a collision, the open circuit trigger immediately disconnects the positive high-voltage loop of the electric automobile and the negative high-voltage loop of the electric automobile, so that the high-voltage of the entire vehicle is powered down, reducing economic loss due to the collision of the electric automobile and human casualties.

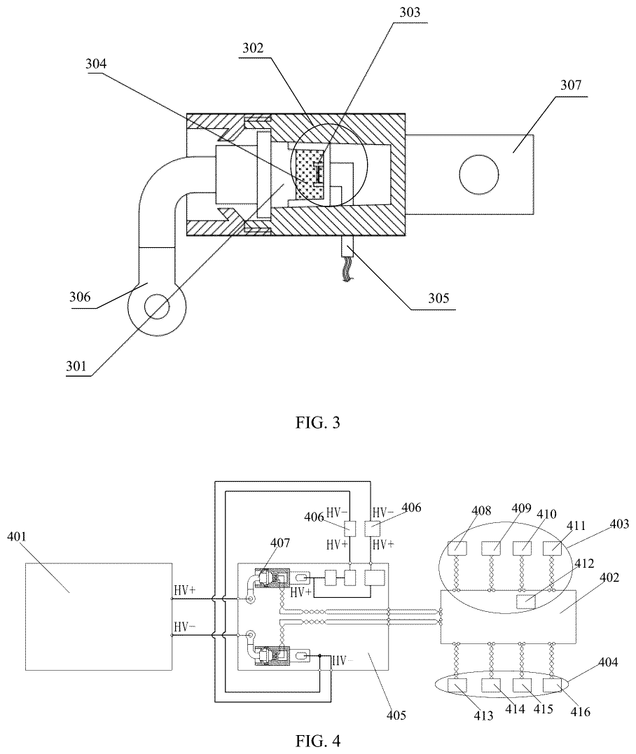

FIG. 4 is a schematic structural diagram of a collision initiation system according to an embodiment of the present disclosure. The structure of the collision initiation system described in this figure includes a high-voltage distribution box 405 provided by the embodiments of the present disclosure, an airbag ECU 402, a collision sensor 403, and an airbag initiator 404.

The airbag ECU 402 is connected to the low-voltage connector of the high-voltage distribution box 405, and the collision sensor 403 and the airbag initiator 404 are respectively connected to the airbag ECU 402.

The airbag ECU 402 is configured to, after determining a collision status of the electric automobile based on a signal of the collision sensor 403 and a signal of the airbag initiator 404, send the initiation control signal to the low-voltage connector of the high-voltage distribution box 405.

In the embodiments of the present disclosure, when the electric automobile experiences a collision, the collision sensor 403 collects a collision signal and sends the collision signal to the airbag ECU 402. The airbag ECU 402 judges whether a collision occurs. If the collision occurs, an initiation control signal is sent to the open circuit trigger 407 of the high-voltage distribution box 405 via the control line of the electric automobile. The low-voltage connector of the high-voltage distribution box 405 is connected to the control line of the electric automobile and sends the initiation control signal to the open circuit trigger 407 of the high-voltage distribution box 405. After receiving the initiation control signal, the open circuit trigger 407 immediately disconnects the high-voltage battery 401 of the electric automobile from the high-voltage appliance 406, so that the high-voltage loop of the electric automobile is powered down.

In addition, when the electric automobile experiences a collision, the airbag initiator 404 quickly initiates the airbag of the automobile to reduce harm to passengers on the automobile. The airbag ECU 402 may further acquire the initiation status of the airbag initiator 404. When the airbag ECU 402 obtains the information of initiation of the airbag initiator 404, an initiation control signal is sent to the open circuit trigger 407 of the high-voltage distribution box 405 via the control line of the electric automobile. After receiving the initiation control signal, the open circuit trigger 407 immediately disconnects the high-voltage battery 401 of the electric automobile from the high-voltage appliance 406, so that the high-voltage loop of the electric automobile is powered down.

In the embodiments of the present disclosure, the airbag ECU 402 can determine the collision status of the collision sensor 403 and the initiation status of the airbag initiator 404 according to the method in the prior art, and details are not described in this specification.

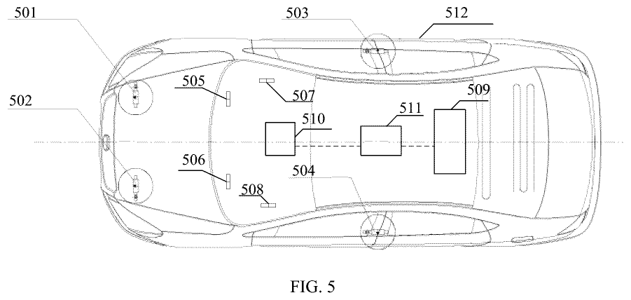

Exemplarily, as shown in FIG. 4, the collision sensor 403 further includes a left front collision sensor 408, a right front collision sensor 409, a left side collision sensor 410, a right side collision sensor 411, and a forward collision sensor 412, all of which are respectively mounted at different positions of the electric automobile as shown in FIG. 5, and configured to detect collision of the electric automobile in all directions to facilitate the airbag ECU 402 to control the initiation of the open circuit trigger 407 of the high-voltage distribution box 405, so that the high-voltage system of the entire vehicle is powered down. The airbag initiator 404 further includes a driver airbag initiator 413, a driver side airbag initiator 414, a passenger airbag initiator 415, and a passenger side airbag initiator 416, all of which are respectively mounted at different positions of the electric automobile as shown in FIG. 5 and configured to detect the initiation status of the airbag of the electric automobile in all directions to facilitate the airbag ECU 402 to control the initiation of the open circuit trigger 407 of the high-voltage distribution box 405, so that the high-voltage system of the entire vehicle is powered down. The driver airbag initiator 413, the driver side airbag initiator 414, the passenger airbag initiator 415, and the passenger side airbag initiator 416 in the embodiments of the present disclosure may be mounted based on hardware configurations of different car models or the needs of the vehicle owners.

FIG. 5 is a schematic structural diagram of an electric automobile according to an embodiment of the present disclosure. The structure of the electric automobile described in this figure includes the collision initiation system provided by the embodiments of the present disclosure, an automobile body 512, and a high-voltage battery 509.

The high-voltage battery 509 and the collision initiation system are provided inside the automobile body 512.

The high-voltage distribution box 511 having an open circuit trigger is connected to the high-voltage battery 509 and configured to control the high-voltage battery 509 to supply power to a high-voltage appliance of the automobile body 512.

In the embodiments of the present disclosure, the airbag ECU 510 sends an initiation control signal to the open circuit trigger of the high-voltage distribution box 511 based on a signal of the right front collision sensor 501, a signal of the left front collision sensor 502, a signal of the right side collision sensor 503, a signal of the left side collision sensor 504, a signal of the passenger airbag initiator 505, a signal of the driver airbag initiator 506, a signal of the passenger side airbag initiator 507, and a signal of the driver side airbag initiator 508. After receiving the initiation control signal, the open circuit trigger immediately disconnects the high-voltage loop of the entire vehicle.

The mounting positions of the right front collision sensor 501, the left front collision sensor 502, the right side collision sensor 503, the left side collision sensor 504, the passenger airbag initiator 505, the driver airbag initiator 506, the passenger side airbag initiator 507, and the driver side airbag initiator 508 may be shown in FIG. 5. The right front collision sensor 501 is configured to detect collision of the right front side of the automobile body 512, the left front collision sensor 502 is configured to detect collision of the left front side of the automobile body 512, the right side collision sensor 503 is configured to detect collision of the right side of the automobile body 512, and the left side collision sensor 504 is configured to detect collision of the left side of the automobile body 512. The passenger airbag initiator 505 is configured to detect initiation of the passenger airbag of the automobile body 512, the driver airbag initiator 506 is configured to detect initiation of the driver airbag of the automobile body 512, the passenger side airbag initiator 507 is configured to detect initiation of the passenger side airbag of the automobile body 512, and the driver side airbag initiator 508 is configured to detect initiation of the driver side airbag of the automobile body 512.

It should be understood that sequence numbers of processes in various embodiments of the present disclosure do not mean execution sequences. The execution sequences of the processes should be determined based on functions and internal logic of the processes, and should not be construed as any limitation on implementation processes of the embodiments of the the present disclosure.

The principle and the implementations of the present disclosure are described in this specification by using specific embodiments. The descriptions about the embodiments are merely provided to help understand the method and the core idea of the present disclosure. In addition, a person of ordinary skill in the art may make changes to the specific implementations and the application scope according to the idea of the present disclosure. Therefore, the content of this specification shall not be construed as a limitation on the present disclosure.

1. A high-voltage distribution box having an open circuit trigger, comprising:
a distribution box housing, a first high-voltage connector, a second high-voltage connector, a low-voltage connector, and an open circuit trigger; wherein
the first high-voltage connector, the second high-voltage connector, and the low-voltage connector are provided on a surface of the distribution box housing, and the open circuit trigger is provided inside the distribution box housing;
the first high-voltage connector and the second high-voltage connector are connected to a high-voltage loop of an electric automobile, and the first high-voltage connector and the second high-voltage connector are connected in series via the open circuit trigger; and
the low-voltage connector is connected to a control line of the electric automobile and configured to send an initiation control signal to the open circuit trigger at a moment of collision.

2. The high-voltage distribution box having the open circuit trigger according to claim 1, wherein the first high-voltage connector comprises a first positive electricity connection terminal and a first negative electricity connection terminal, the second high-voltage connector comprises a second positive electricity connection terminal and a second negative electricity connection terminal, and the open circuit trigger further comprises a main positive open circuit trigger and a main negative open circuit trigger; wherein
the main positive open circuit trigger is connected in series between the first positive electricity connection terminal and the second positive electricity connection terminal, and the main negative open circuit trigger is connected in series between the first negative electricity connection terminal and the second negative electricity connection terminal.

3. The high-voltage distribution box having the open circuit trigger according to claim 1, wherein the open circuit trigger further comprises a connecting pin and a trigger, and the connecting pin is movably connected between a first end of the open circuit trigger and a second end thereof; and
the trigger is provided at an end of the connecting pin and connected to the low-voltage connector and receives the initiation control signal.

4. The high-voltage distribution box having the open circuit trigger according to claim 3, wherein the trigger further comprises a trigger resistor and an expansion component, the trigger resistor is connected to the low-voltage connector, and the expansion component is provided at an end of the connecting pin; and
the trigger resistor is configured to, upon receipt of the initiation control signal, control the expansion component to swell and deform to enable the connecting pin to disconnect the connection between the first end of the open circuit trigger and the second end thereof.

5. The high-voltage distribution box having the open circuit trigger according to claim 4, wherein the expansion component is an explosive.

6. The high-voltage distribution box having the open circuit trigger according to claim 1, wherein the high-voltage distribution box further comprises a high-voltage repeater, and the high-voltage repeater is provided inside the distribution box housing;
the high-voltage repeater and the open circuit trigger are connected in series between the first high-voltage connector and the second high-voltage connector; and
the low-voltage connector is further configured to, in a normal operation state, receive a control signal sent to the high-voltage repeater.

7. The high-voltage distribution box having the open circuit trigger according to claim 1, wherein the high-voltage distribution box further comprises a high-voltage circuit breaker and the high-voltage circuit breaker is provided inside the distribution box housing;
the high-voltage open circuit trigger and the open circuit trigger are connected in series between the first high-voltage connector and the second high-voltage connector; and
the high-voltage open circuit trigger is configured to disconnect the series connection of the first high-voltage connector and the second high-voltage connector in a case of a short circuit in the high-voltage loop of the electric automobile or an excess load of the electric automobile.

8. The high-voltage distribution box having open circuit trigger according to claim 1, wherein the high-voltage distribution box further comprises a copper busbar and an insulation fixing block, and the copper busbar and the insulation fixing block are provided inside the distribution box housing;
the copper busbar and the open circuit trigger are connected in series between the first high-voltage connector and the second high-voltage connector, to conduct a high-voltage current between the first high-voltage connector and the second high-voltage connector inside the distribution box housing; and
the insulation fixing block wraps the copper busbar and is configured to fix the copper busbar inside the distribution box housing.

9. A collision initiation system, comprising the high-voltage distribution box having the open circuit trigger according to claim 1, an airbag ECU, a collision sensor, and an airbag initiator; wherein
the airbag ECU is connected to a low-voltage connector of the high-voltage distribution box having the open circuit trigger, and the collision sensor and the airbag initiator are respectively connected to the airbag ECU; and
the airbag ECU is configured to, after determining a collision status of an electric automobile based on a signal of the collision sensor and a signal the airbag initiator, send an initiation control signal to the low-voltage connector of the high-voltage distribution box having the open circuit trigger.

10. An electric automobile, comprising the collision initiation system according to claim 9, an automobile body, and a high-voltage battery; wherein
the high-voltage battery and the collision initiation system are provided inside the automobile body; and
the high-voltage distribution box having the open circuit trigger is connected to the high-voltage battery and configured to control the high-voltage battery to supply power to a high-voltage appliance of the automobile body.

11. The high-voltage distribution box having the open circuit trigger according to claim 2, wherein the open circuit trigger further comprises a connecting pin and a trigger, and the connecting pin is movably connected between a first end of the open circuit trigger and a second end thereof; and
the trigger is provided at an end of the connecting pin and connected to the low-voltage connector and receives the initiation control signal.

12. The high-voltage distribution box having the open circuit trigger according to claim 11, wherein the trigger further comprises a trigger resistor and an expansion component, the trigger resistor is connected to the low-voltage connector, and the expansion component is provided at an end of the connecting pin; and
the trigger resistor is configured to, upon receipt of the initiation control signal, control the expansion component to swell and deform to enable the connecting pin to disconnect the connection between the first end of the open circuit trigger and the second end thereof.

13. The high-voltage distribution box having the open circuit trigger according to claim 12, wherein the expansion component is an explosive.
